(19) United States
(12) Patent Application Publication
(10) Pub. No.: US 2007/0201626 A1
(43) Pub. Date: Aug. 30, 2007

(54) Non-linear voicemail

(75) Inventor: Yair Winkler, Caesarea (IL)

Correspondence Address: BROWDY AND NEIMARK, P.L.L.C.;624 NINTH STREET, NW, SUITE 300, WASHINGTON, DC, 20001-5303, US

(73) Assignee: Festin Enterprises Corporation, Der Stadt (PA)

(21) Appl. No.: 11/350,114

(22) Filed: Feb. 9, 2006

(51) Int. Cl. H04M 1/64

(52) U.S. Cl. 379/67.1

(57) ABSTRACT

The present invention relates to a telecommunication system and methods for accessing and using a voicemail system from a mobile terminal, via a visual or voice interface. The present invention enables the user to access a message directly, in a non-linear way, without needing to go through all previous messages sequentially. The mobile terminal user visualizes a list of all new voicemail messages, or alternatively can listen to a description or summary of available voicemail messages. Each voicemail message preferably includes some additional details including date and time the message was left, the duration of the message, the caller's number when such information is available, and the sequential number of the message in the list. In addition, the system displays the total number of new messages available.

### FIELD OF THE INVENTION

The present invention relates to a communication system and methods for accessing and using a voicemail system from a mobile terminal, preferably via a visual interface.

### BACKGROUND OF THE INVENTION

Before voicemail systems were popular, when someone did not answer his or her phone, the caller would simply have to try and call later. Nowadays, almost every personal or professional telephone is connected to a voicemail system where the caller can leave a message that can be heard by the receiver at a later stage.

Mobile operators typically bundle a voicemail box for each subscriber. The voicemail system offers an obvious benefit to the subscriber; the subscriber can receive messages when he is already engaged in another communication, when he is away from his phone, when the phone is turned off, when he is in an area without adequate network reception, or simply if he does not wish to answer the call.

Mobile operators view voicemail as an important source of revenues. Some operators charge subscribers for the airtime used when listening to voicemails. Even if the service is offered for free to subscribers, operators enjoy additional usage revenues as a consequence of voicemail systems. When a subscriber receives a message, he will frequently call back the caller. Without the voicemail system, the caller would try again to reach the mobile subscriber, and the mobile subscriber would not generate an outgoing call.

Access to the voicemail system is typically done via a voice interface. The voicemail system may announce initially the total number of new messages available. The user then needs to go through and listen, or partially listen, to each message in order to get to the next one. The messages are typically sorted by the order they were received, thus the most recent message, that was left last, will be heard last. The voicemail system may also provide some additional information for each message such as time and date it was left, the duration of the message, and when available also the phone number of the caller.

The result of the above is that the user of the voicemail system cannot access or see the details of a recent message, until he is done with all the previous messages. This sequential access to voicemail messages prohibits the user from getting direct access to one specific message, and instead forces the user to engage in a more time-consuming process of going through the messages one by one.

It would be desirable to enable the user to know how many messages he has, along with the relevant identifying information, and then enable the user to access directly any message he wishes to. This is the way people use an email system. One can see all new messages along with the sender and subject, and then decide which message he wants to open first.

### SUMMARY OF THE INVENTION

The present invention relates to a telecommunication system and methods for accessing and using a voicemail system from a mobile terminal, via a visual or voice interface. The present invention enables the user to access a message directly, in a non-linear way, without needing to go through all previous messages sequentially. The mobile terminal user visualizes a list of all new voicemail messages, or alternatively can listen to a description or summary of available voicemail messages. Each voicemail message preferably includes some additional details including date and time the message was left, the duration of the message, the caller's number when such information is available, and the sequential number of the message in the list. In addition, the system displays the total number of new messages available.

The mobile terminal user can then visually scan the list and access each message directly, in any order he wishes to. Alternatively, the user can access each message directly either by pressing the appropriate keys of a touch-tone terminal (thus generating Dual-Tone Multi-Frequency commands) or by speaking out the right command that is recognized by a voice-recognition system. For each selected voicemail message from the list, the user can apply any available voicemail command. In one illustrative embodiment, voicemail commands are selected from the group consisting of: LISTEN to message, DELETE message, SAVE MESSAGE to be heard later, CALLBACK the caller, ADD PHONE NUMBER of the caller to said mobile terminal phone book, and REPLY BY SMS to the caller, but other suitable voicemail commands are encompassed by the present invention.

Preferably, a notification is sent to the mobile terminal shortly after a new voicemail message is left on the voicemail system.

### BRIEF DESCRIPTION OF THE DRAWINGS

FIG. 1 is a block diagram of a telecommunication system of the invention comprising a mobile terminal, a communication server, and a voicemail system.

FIG. 2 is an example of a voicemail message list displayed on a mobile terminal's screen.

FIG. 3 is an illustration of voicemail commands that a user can apply to previously selected voicemail messages.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to a method for accessing and using a voicemail system from a mobile terminal, equipped with adapted software or hardware logic, via a visual or voice interface, said method comprising the steps of:
(i) visualizing on said mobile terminal, or listening to a description of, a list of voicemail messages available on said voicemail system;
(ii) selecting one or more voicemail messages from said list;
(iii) selecting an available voicemail command; and
(iv) executing selected voicemail command for all selected voicemail messages.

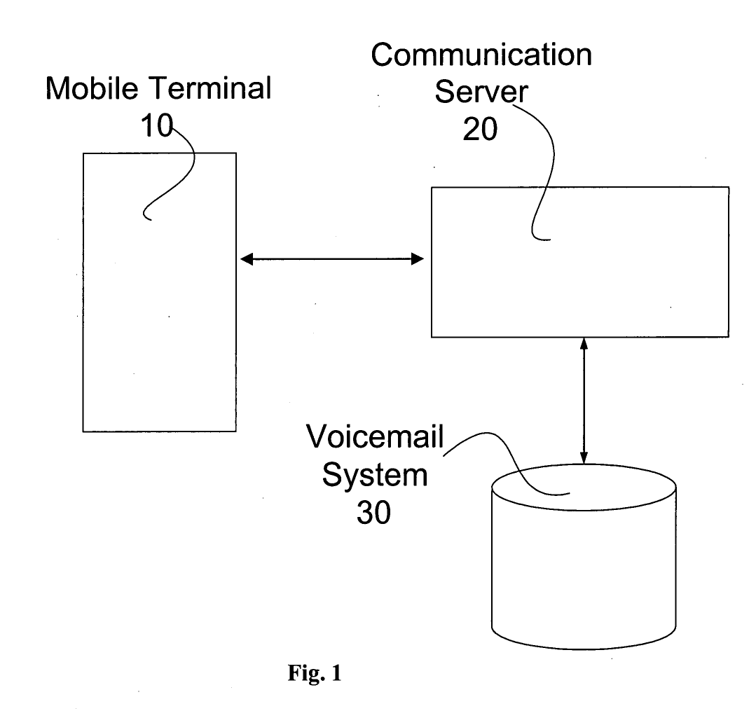

FIG. 1 shows a telecommunication system according to the present invention for the implementation of said method, comprising a mobile terminal 10 connected via wireless means to a predefined communication server 20 that in turn communicates with a voicemail system 30.

The telecommunication system according to the present invention enables access and use of a voicemail system 30 from a mobile terminal 10, equipped with adapted software or hardware logic, via a visual interface, wherein said system comprises:
(i) means for visualizing on said mobile terminal 10 a list of voicemail messages available on said voicemail system 30;
(ii) means for selecting one or more voicemail messages from said list;
(iii) means for selecting an available voicemail command;
(iv) a predefined communication server 20; and
(v) means for executing selected voicemail command for all selected voicemail messages.

The mobile terminal 10 is equipped with adapted software or hardware logic that interacts with the predefined communication server 20 and the mobile terminal 10 user.

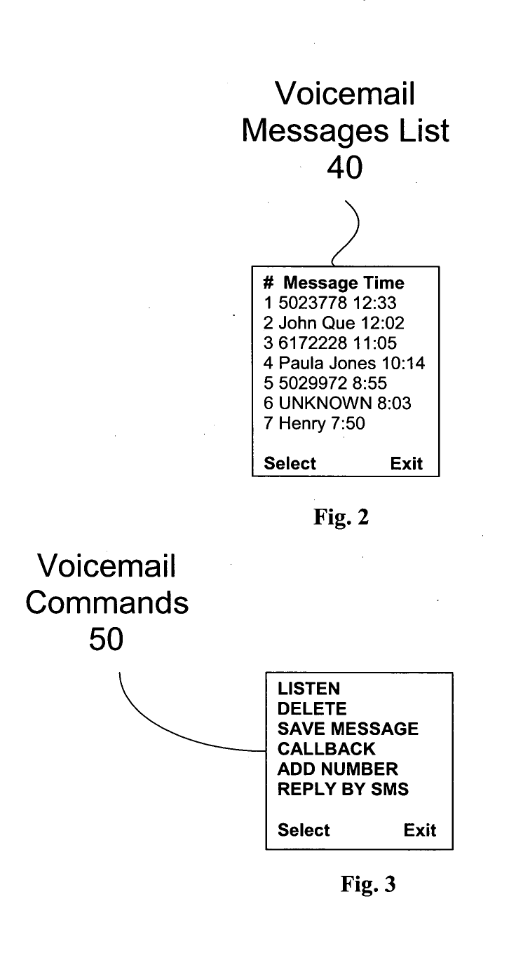

FIG. 2 illustrates an example of a voicemail messages list 40 as displayed on the screen of a mobile terminal 10. A list of 7 voicemail messages in displayed in this example, each with summary identifying information, in this case: the sequential message number, caller's details and the time the voicemail message was left. Each voicemail message can have additional identifying information including the date the message was left and the duration of the message. Since a mobile terminal 10 has a limited screen size, displaying information can be organized according to different preferences. In the example of FIG. 2, 7 messages are displayed on one screen, but not with all the available identifying information. Once a voicemail message is selected, additional identifying information can be displayed in a second screen.

It can easily be conceived that all available identifying information is displayed for each voicemail message, thus making the voicemail messages list 40 shorter, displaying less messages per screen.

Sometimes, the caller's phone number is not available to the voicemail system, either because the caller selected not to identify his calling number or because the mobile network did not pass on this information. In the example of FIG. 2, message number 6 is marked from UNKNOWN.

In one embodiment of the present invention, the adapted software or hardware logic compares the caller phone numbers of the voicemail messages list 40 with phone numbers in the mobile terminal 10 phone book memory. If a caller number is found within the mobile terminal 10 phone book memory, then the voicemail messages list 40 will display the name associated with the phone book phone number instead. Thus in the example of FIG. 2, messages 2, 4 and 7 are shown as from John Que, Paula Jones and Henry accordingly instead of displaying their phone numbers. This is far more convenient for the mobile terminal 10 user, as he can recognize immediately who the call was from.

FIG. 3 illustrates an example of voicemail commands 50 as displayed on the screen of a mobile terminal 10. The selected command from the voicemail commands 50 list will be applied to any previously selected voicemail message or messages. FIG. 3 shows an example of voicemail commands 50 that can be applied to one or more voice messages: LISTEN—sends instructions to the predefined communication server 20 to connect the mobile terminal 10 with the voicemail system 30 and instructs the voicemail system 30 to play the selected voicemail message or messages; DELETE—sends instructions to the predefined communication server 20 to connect to the voicemail system 30 and instructs the voicemail system 30 to delete the selected voicemail message or messages; SAVE MESSAGE—sends instructions to the predefined communication server 20 to connect to the voicemail system 30 and instructs the voicemail system 30 to save the selected voicemail message or messages so that they can be available for later use; CALLBACK—sends instructions to the predefined communication server 20 to connect the mobile terminal 10 with the caller phone number associated with the selected voicemail message or messages; ADD NUMBER—adds the phone number of the caller of the selected message or messages to the mobile terminal 10 phone book; and REPLY BY SMS—enables the mobile terminal 10 user to send a short message (SMS) as a reply to the selected voicemail message or messages.

The present invention may further contain means for alerting the mobile terminal 10 after a new voicemail message is left on the voicemail system 30. It is far more convenient for the user to receive an alert after a new voicemail message has been left, rather than check periodically if there are any new voicemail messages waiting. The notification for a new message can be achieved in various ways such as over the air activation (OTA), an SMS message, via the Web, via an email message or via Unstructured Supplementary Services Data (USSD). OTA is a very convenient way for updating the mobile terminal 10 when a new voicemail message arrives to the voicemail system 30. One advantage that OTA has over other methods for sending information to a mobile terminal 10 is that OTA is aware if the mobile terminal 10 is turned on and can receive messages, or if it is not available in the network. A mobile terminal 10 may be either turned off or in a zone without adequate network coverage. Once the mobile terminal 10 is confirmed to be available in the mobile network, the mobile terminal 10 receives one or more hidden short messages (SMS) with the pertinent information regarding the new voicemail messages left on the voicemail system 30. The adapted software or hardware logic on mobile terminal 10 then receives the notification about the new voicemail message received and alerts the mobile terminal 10 user via a visual and/or audio indication.

The adapted software or hardware logic in said mobile terminal 10 may take several forms. It may be a Subscriber Identification Module (SIM) Toolkit application, or a higher-level application, for example in C++ or in Java in higher end terminals known as smart phones. The adapted software or hardware logic in mobile terminal 10 may be delivered with the mobile terminal 10 at the moment of purchase, or added at a later stage.

Using the SIM Toolkit to develop an application to interact with the end-user and with the predefined communication server 20 is very convenient since SIM Toolkit applications work with a very large number of mobile terminals. Smart phone applications, aided by the smart-phone typical larger screen and increased memory, are more user-friendly for the end-user though the number of smart-phones is more limited.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not limitation. The invention described herein in the recited claims intends to cover and embrace suitable changes in the technology.

1. A method for accessing and using a voicemail system from a mobile terminal, equipped with adapted software or hardware logic, via a visual or voice interface, said method comprising the steps of:
(i) visualizing on said mobile terminal, or listening to a description of, a list of voicemail messages available on said voicemail system;
(ii) selecting one or more voicemail messages from said list;
(iii) selecting an available voicemail command; and
(iv) executing selected voicemail command for all selected voicemail messages.

2. The method according to claim 1, wherein said list contains identifying information for each voicemail message.

3. The method according to claim 2, wherein said identifying information is selected from the group consisting of: (i) sequential message number, (ii) date and time message was left, (iii) duration of the call, (iv) caller's phone number, and (v) any combination of (i) to (iv).

4. The method according to claim 3, wherein said caller's phone number, when existing in the phone book memory of said mobile terminal, is replaced with the name associated with said caller's phone number in said mobile terminal phone book.

5. The method according to claim 1, wherein said voicemail command is selected from the group consisting of: LISTEN to message, DELETE message, SAVE MESSAGE to be heard later, CALLBACK the caller, ADD PHONE NUMBER of the caller to the phone book of said mobile terminal, and REPLY BY SMS to the caller.

6. The method according to claim 5, wherein said voicemail command is executed by pressing the appropriate keys of a touch-tone mobile terminal or by recognizing a spoken command via voice-recognition.

7. The method according to claim 1, wherein a notification is received on said mobile terminal after one or more new voicemail messages are left on said voicemail system;

8. The method according to claim 7, wherein said notification is done via an Over The Air (OTA) application server.

9. The method according to claim 1, wherein said adapted software or hardware logic is a SIM Toolkit application.

10. A telecommunication system for accessing and using a voicemail system from a mobile terminal, equipped with adapted software or hardware logic, via a visual interface, wherein said system comprises:
(i) means for visualizing on said mobile terminal a list of voicemail messages available on said voicemail system;
(ii) means for selecting one or more voicemail messages from said list;
(iii) means for selecting an available voicemail command;
(iv) a predefined communication server; and
(v) means for executing selected voicemail command for all selected voicemail messages.

11. The system according to claim 10, wherein said list contains identifying information for each voicemail message.

12. The system according to claim 11, wherein said identifying information is selected from the group consisting of: (i) sequential message number, (ii) date and time message was left, (iii) duration of the call, (iv) caller's phone number, and (v) any combination of (i) to (iv).

13. The method according to claim 12, wherein said caller's phone number, when existing in the phone book memory of said mobile terminal, is replaced with the name associated with said caller's phone number in said mobile terminal phone book.

14. The system according to claim 10, wherein said voicemail command is selected from the group consisting of: LISTEN to message, DELETE message, SAVE MESSAGE to be heard later, CALLBACK the caller, ADD PHONE NUMBER of the caller to the phone book of said mobile terminal, and REPLY BY SMS to the caller.

15. The method according to claim 14, wherein said voicemail command is executed by pressing the appropriate keys of a touch-tone mobile terminal or by recognizing a spoken command via voice-recognition.

16. The system according to claim 10, wherein a notification is received on said mobile terminal after one or more new voicemail messages are left on said voicemail system.

17. The system according to claim 16, wherein said notification is done via an Over The Air (OTA) application server.

18. The system according to claim 10, wherein said adapted software or hardware logic is a SIM Toolkit application.
